(19) United States
(12) Patent Application Publication
(10) Pub. No.: US 2025/0356199 A1
(43) Pub. Date: Nov. 20, 2025

(54) RESOURCE-AWARE MODEL-DRIVEN LATENCY PREDICTION FOR MODEL SERVING

(71) Applicant: Adobe Inc., San Jose, CA (US)

(72) Inventors: Qianlin LIANG, Amherst, MA (US); Haoliang Wang, Sunnyvale, CA (US)

(21) Appl. No.: 18/669,193

(22) Filed: May 20, 2024

(51) Int. Cl. G06N 3/0895; G06N 3/04

(52) U.S. Cl. CPC G06N 3/0895; G06N 3/04

(57) ABSTRACT

Some aspects relate to technologies for using machine learning models to predict latency for executing neural networks on various hardware configurations. In accordance with some aspects, a neural network representation for a target neural network having a plurality of layers is received. A first machine learning model groups layers of the target neural network to provide a plurality of layer groups based on the neural network representation, with at least one layer group comprising multiple layers from the target neural network that can be executed by a single operation. A second machine learning model generates a latency prediction for executing the target neural network on a target hardware configuration based on the layer groups.

### BACKGROUND

Neural networks have undergone rapid development and have become a fundamental building block for a broad spectrum of applications, such as, for instance, autonomous vehicles, video analytics, and recommendation systems. Often, cloud and edge computing resources are used to support these neural network applications. Model serving is a popular approach for running deep learning inference tasks using cloud or edge resources. Model serving involves hosting pre-trained neural network models on graph processing unit (GPU) or central processing unit (CPU) resources in the cloud and offering the ability to remotely invoke these models on demand based on the applications' inference needs.

### SUMMARY

Some aspects of the present technology relate to, among other things, using machine learning models to generate latency predictions for executing neural networks on different hardware configurations. Given a target neural network having various layers, a first machine learning model predicts the fusibility of connected layers to facilitate partitioning the neural network into layer groups where each layer group includes a single layer from the target neural network or multiple layers from the target neural network that can be executed by a single operation. Given the layer groups from the target neural network and a target hardware configuration, a second machine learning model generates a latency prediction for executing each layer group on the target hardware configuration. In some aspects, the second machine learning model also predicts a kernel for each layer group. The latency predictions for each layer group are aggregated to provide a total latency prediction for executing the target neural network on the target hardware configuration.

Some configurations of the technology described herein employ a graph-based approach in which the first machine learning model is a first graph neural network model that processes a graph representation of the target neural network in which nodes represent the layers of the target neural network and edges between nodes represent connections between the layers. The first graph neural network generates edge labels identifying the edges as fusible or not fusible based on layer features. The graph representation of the target neural network is then partitioned into sub-graphs where each sub-graph includes nodes with edges labeled as fusible. In such configurations, the second machine learning model is a second graph neural network that generates latency predictions (and kernel predictions, in some aspects) for the sub-graphs.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is block diagram illustrating operation of a model analysis system to predict a latency of executing a target neural network on a target hardware configuration in accordance with some implementations of the present disclosure;

FIG. 3 is a block diagram illustrating a graph-based approach for predicting a latency of executing a target neural network on a target hardware configuration in accordance with some implementations of the present disclosure;

FIG. 4 is a diagram showing a user interface for inputting a target neural network and a target hardware configuration for generating a latency prediction in accordance with some implementations of the present disclosure;

FIG. 5 is a diagram showing a user interface providing a latency prediction and layer latency details in accordance with some implementations of the present disclosure;

FIG. 6 is a flow diagram showing an overall method for predicting a latency of executing a target neural network on a target hardware configuration in accordance with some implementations of the present disclosure;

FIG. 7 is a flow diagram showing a method for employing a graph neural network to partition a target neural network in accordance with some implementations of the present disclosure;

FIG. 8 is a flow diagram showing a method for a graph neural network to label edges of a graph representation of a target neural network in accordance with some implementations of the present disclosure;

FIG. 9 is a flow diagram showing a method for using a machine learning model to predict a latency for executing a target neural network on a target hardware configuration in accordance with some implementations of the present disclosure; and

FIG. 10 is a block diagram of an exemplary computing environment suitable for use in implementations of the present disclosure.

### DETAILED DESCRIPTION

### Overview

Neural network models vary significantly in their size, complexity, and computational requirements. Additionally, neural network models have increased in size and complexity in recent years, posing a challenge to using the appropriate hardware and resources to serve these models with high performance and cost efficiency. Furthermore, neural network inference applications often have strict Service Level Objectives (SLO) needs in terms of their latency requirements. At the same time, GPU and other resources in edge or cloud platforms can be expensive, making cost of model serving an important consideration.

Given the diversity of neural network models and their computational complexity, it has become increasingly challenging for a model serving platform to choose the right hardware resources (e.g., GPU) to run each neural network model. An incorrect choice can have cost or performance implications. For example, choosing a low-end GPU for a complex neural network model may not provide sufficient computational resources to meet the desired latency SLO, resulting in poor performance. Conversely, selecting a high-end GPU for a less complex neural network model may lead to resource underutilization and high cloud costs. Further, many model serving platforms multiplex a single GPU across multiple neural network services to improve utilization and amortize costs. Such advanced features improve resource utilization and reduce costs, but make the GPU resource provisioning problem more challenging.

Conventionally, model serving platforms have used a number of approaches for estimating the expected latency of executing neural network models on different GPU configurations in order to choose hardware resources to use for each model. But each of these approaches presents limitations. For instance, one approach for estimating latency is through empirical profiling, which involves running a neural network model on the target hardware to measure the execution latency. However, profiling is a time consuming and computer resource-intensive process since it can involve executing the model on numerous hardware configurations in order to choose one to deploy the model on. Further, as the number of model and hardware variants increase (e.g., Neural Architecture Search (NAS) can produce hundreds of model variants for each application), the overhead of exhaustive profiling can quickly accumulate and become impractical in some settings.

An alternative to empirical profiling is to use a model to predict the execution latency of a neural network model. Numerous recent efforts have developed model-driven approaches that use analytic methods or a machine learning model to predict the inference latency for a neural network model. One class of approaches focus on end-to-end prediction by considering the entire neural network model and use various approaches to predict the execution latency for a specific hardware configuration. Such approaches require training a model for each type of hardware configuration and do not generalize easily for unseen hardware or model variants. For example, some methods rely heavily on the graph patterns learned from the training data and often fail to generalize to unseen neural network models.

Other approaches have focused on modeling the internal structure of the neural network models to estimate latency. For example, layer-based approaches predict the latency to execute each layer and then estimate the total latency on the sum of the layer-specific latencies. Since components such as layers are often reused across models, the approach has the potential to generalize across model variants. However, a significant limitation of layer-based approaches is their inability to account for runtime optimization such as layer fusion, which involves combining adjacent layers into a single layer or operation for performance optimization and is common in runtime frameworks for improving performance. As a result, layer-based approaches end up overestimating total latency since they focus on individual layers and do not account for latency reduction from fusing layers. To overcome this drawback, some kernel-based approaches have been developed, where latency is estimated at kernel, rather than layer granularity. Since a kernel can include one or more layers, including fused layers, it can improve the accuracy of the latency estimations. Current kernel-based approaches partition the model into multiple kernels by using handcrafted fusion rules to determine which layers might be fused at runtime, followed by building latency regressors for each kernel to estimate total latency. However, handcrafting fusion rules can be time consuming and error-prone, and they may need to be changed frequently due to rapid advances in deep learning frameworks. Thus, existing methods suffer from many limitations, including the inability to handle runtime optimization and the inability to generalize to newer models or hardware.

Aspects of the technology described herein improve the functioning of the computer itself in light of these shortcomings in existing technologies by providing an efficient and accurate latency predicting system for a wide range of neural network inference tasks across diverse hardware resource allocations (e.g., dedicated GPUs and arbitrarily provisioned GPU resources). Some configurations employ two techniques to generate a latency prediction for executing a target neural network on a target hardware configuration. In particular, a first machine learning model is used to learn operator fusion rules and partition the target neural network by execution units that group layers of the target neural network executable by a single operation. A second machine learning model then generates latency predictions for each layer group and, in some aspects, also predicts a kernel for each layer group. A total latency prediction for executing the target neural network on the target hardware configuration is provided by aggregating the latency predictions for the layer groups.

Some configurations employ a graph model-based approach. In such configurations, the structure of the neural network is represented as a graph, and the graph structure is used to automatically infer fusion rules. More specifically, a graph representation of a target neural network is generated in which the nodes represent layers of the target neural network and the edges represent connections between the layers. Based on layer features associated with each node, a first graph neural network (GNN) predicts edge labels identifying each edge as fusible or not fusible. The graph is then partitioned into fusion-aware sub-graphs such that the layers within each sub-graph can be fused and executed by a single operation. A second GNN then generates a latency prediction for executing each sub-graph on a target hardware configuration, and a total latency prediction is generated by aggregating the latency predictions of the sub-graphs. In some aspects, the second GNN also predicts a kernel for each sub-graph.

Aspects of the technology described herein provide a number of improvements over existing technologies. For instance, the technology described herein provides a solution capable of accurately and efficiently predicting inference latency of a wide range of neural network structures across diverse hardware configurations. Unlike prior methods, aspects described herein can predict latency for both dedicated GPUs and GPUs with arbitrary resource provisions. Instead of using hardcoded fusion rules, aspects employ a machine learning model to learn fusion rules for each individual neural network, thereby allowing the system to generalize well across both neural network and hardware variants. Graph-based approaches described herein provide further advantages. Given a runtime platform, the fusion pattern of neural network layers tend to remain relatively stable and consistent across different models. Although GNNs may struggle to generalize to globally unseen graph structures (i.e. graph-level prediction), they remain effective in capturing those unchanged local patterns (e.g. conv-relu pattern appears in almost every CNN-based models). Additionally, the structure space of the sub-graphs is relatively small. As such, the graph-based approaches leverage the strengths of GNNs in learning and representing graph-level information to provide accurate latency prediction and kernel classification. Moreover, by shifting from the graph-level prediction to sub-graph level, the size of the training dataset can increase significantly, which increases the accuracy and generalizability of the models.

### Example System for Latency Prediction for Model Serving

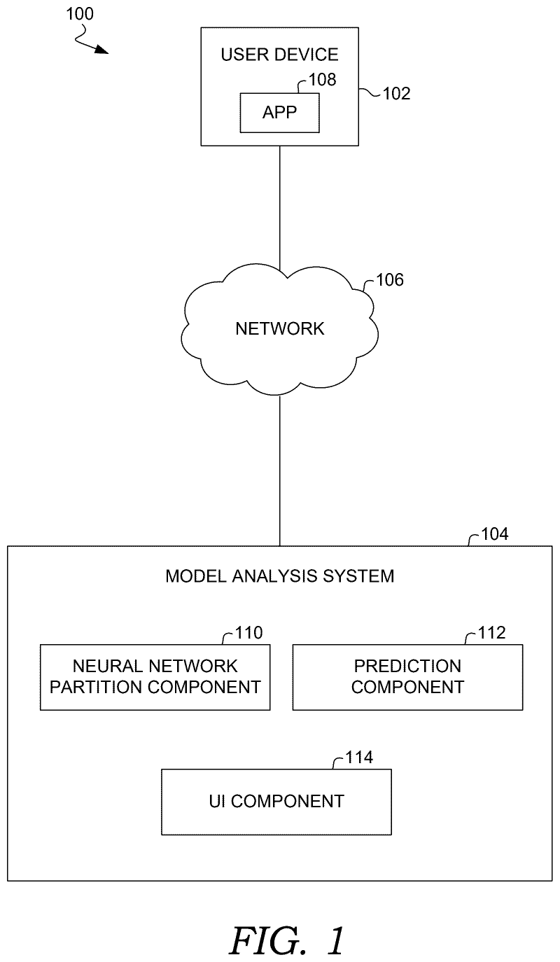

With reference now to the drawings, FIG. 1 is a block diagram illustrating an exemplary system 100 that generates latency predictions for executing neural networks on various hardware configurations in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

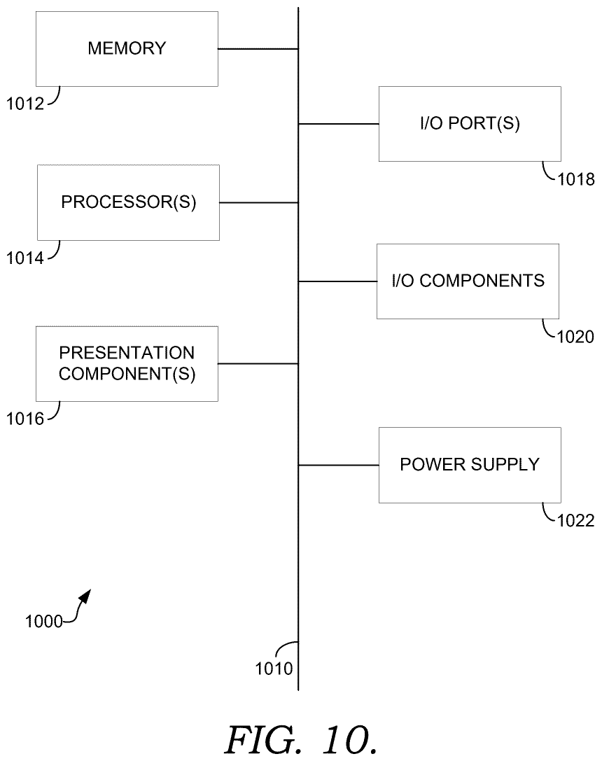

The system 100 is an example of a suitable architecture for implementing certain aspects of the present disclosure. Among other components not shown, the system 100 includes a user device 102 and a model analysis system 104. Each of the user device 102 and the model analysis system 104 shown in FIG. 1 can comprise one or more computer devices, such as the computing device 1000 of FIG. 10, discussed below. As shown in FIG. 1, the user device 102 and the model analysis system 104 can communicate via a network 106, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100 within the scope of the present technology. Each may comprise a single device or multiple devices cooperating in a distributed environment. For instance, the model analysis system 104 could be provided by multiple server devices collectively providing the functionality of the model analysis system 104 as described herein. Additionally, other components not shown may also be included within the network environment.

The user device 102 can be a client device on the client-side of operating environment 100, while the model analysis system 104 can be on the server-side of operating environment 100. The model analysis system 104 can comprise server-side software designed to work in conjunction with client-side software on the user device 102 so as to implement any combination of the features and functionalities discussed in the present disclosure. For instance, the user device 102 can include an application 108 for interacting with the model analysis system 104. The application 108 can be, for instance, a web browser or a dedicated application for providing functions, such as those described herein. This division of operating environment 100 is provided to illustrate one example of a suitable environment, and there is no requirement for each implementation that any combination of the user device 102 and the model analysis system 104 remain as separate entities. While the operating environment 100 illustrates a configuration in a networked environment with a separate user device and model analysis system, it should be understood that other configurations can be employed in which aspects of the various components are combined. For instance, in some aspects, aspects of the model analysis system 104 can be implemented in part or in whole by the user device 102.

The user device 102 may comprise any type of computing device capable of use by a user. For example, in one aspect, a user device may be the type of computing device 1000 described in relation to FIG. 10 herein. By way of example and not limitation, the user device 102 may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A user may be associated with the user device 102 and may interact with the model analysis system 104 via the user device 102.

The model analysis system 104 predicts latency for a diverse range of neural networks on various hardware configurations. As shown in FIG. 1, the model analysis system 104 includes a neural network partition component 110, a prediction component 112, and a user interface component 114. The modules/components of the model analysis system 104 may be in addition to other components that provide further additional functions beyond the features described herein. The model analysis system 104 can be implemented using one or more server devices, one or more platforms with corresponding application programming interfaces, cloud infrastructure, and the like. While the model analysis system 104 is shown separate from the user device 102 in the configuration of FIG. 1, it should be understood that in other configurations, some or all of the functions of the model analysis system 104 can be provided on the user device 102. Additionally, in some configurations, one or more of the components of the model analysis system 104 shown in FIG. 1 can be provided by the user device 102 and/or another location not shown in FIG. 1. The components can be provided by a single entity or multiple entities.

In some aspects, the functions performed by components of the model analysis system 104 are associated with one or more applications, services, or routines. In particular, such applications, services, or routines may operate on one or more user devices, servers, may be distributed across one or more user devices and servers, or be implemented in the cloud. Moreover, in some aspects, these components of the model analysis system 104 may be distributed across a network, including one or more servers and client devices, in the cloud, and/or may reside on a user device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, functionality of these components can be shared or distributed across other components.

The model analysis system 104 predicts end-to-end latency of executing a target neural network on a target hardware configuration by: using a first machine learning model to partition the target neural network into layer groups; using a second machine learning model to predict latency for each layer group; and determining the total latency as a sum of the layer group latencies. More particularly, a target neural network and a target hardware configuration are provided as input to the model analysis system 104. For instance, a representation of the target neural network could be received in a standard format, such as ONNX, that identifies layers of the target neural network and connections between layers. The target hardware configuration can include information, such as a specific hardware device (e.g., GPU model), number of stream multiprocessors (SM), memory bus width, Compute Unified Device Architecture (CUDA) cores, memory clock rate, and compute clock rate.

Given the target neural network, the network partition component 110 of the model analysis system 104 employs a first machine learning model (also referred to herein as a “partition model”) to partition the target neural network into layer groups. Each layer group comprises one or more layers of the target neural network that can be executed by a single operation (e.g., a GPU kernel). For instance, some layer groups may each comprise a single layer from the target neural when the partition model predicts the single layer cannot be fused with another layer; while other layers groups may each comprise multiple layers from the target neural network when the partition model predicts the layers can be fused and executed by a single operation.

Based on the predicted layer groups from the network partition model 110 and the target hardware configuration, the prediction component 112 employs a second machine learning model (also referred to herein as a “prediction model”) to generate a latency prediction for each layer group on the target hardware configuration. In some configurations, the prediction component 112 also predicts a kernel for each layer group. The prediction component 112 provides a total latency prediction for execution of the target neural network on the target hardware configuration as a sum of the layer group latency predictions. The prediction component 112 can also generate an optimized representation of the target neural network that shows resulting layer groups (indicating their underlying layers from the target neural network) and connections between the layer groups. Each layer group is effectively a layer in the optimized representation since each layer group can be executed using a single operation. The optimized representation can further include an indication of the predicted latency and predicted kernel for each layer group.

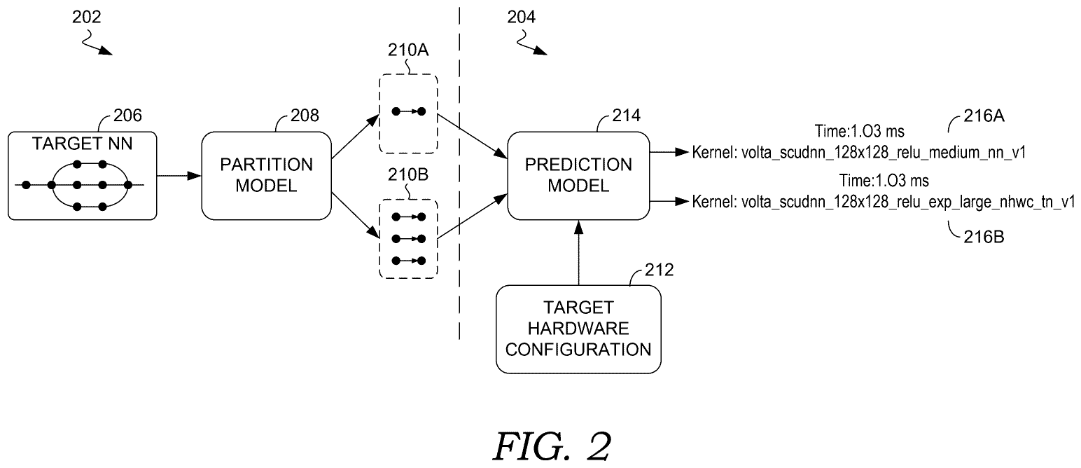

FIG. 2 provides a block diagram illustrating operation of the model analysis system 104, including a first step 202 performed by the neural network partition component 110 and a second step 204 performed by the prediction component 112. In the first step 202, a target neural network 206 is received for analysis. The target neural network 206 is provided as input to a partition model 208 that identifies fusible layers in the neural network in order to form layer groups 210A, 210B based on the fusible layers. While the example of FIG. 2 shows only two layer groups for simplicity purposes, it should be understood that any number of layer groups can be formed. Each layer group includes a single layer from the target neural network (in cases in which the prediction model 208 determines the layer is not fusible with other layers) or two or more layers from the target neural network (in cases in which the prediction model 206 determines the layers are fusible).

In the second step 204, a target hardware configuration 212 is received. The target hardware configuration 212 and the layer groups 210A, 210B are provided as input to a prediction model 214 that generates a latency prediction and a kernel prediction for each layer group—i.e., a latency and kernel prediction 216A for layer group 210A and a latency and kernel prediction 216B for layer group 210B. A total latency prediction for the target neural network can be provided as a sum of the latency predictions for the layer groups.

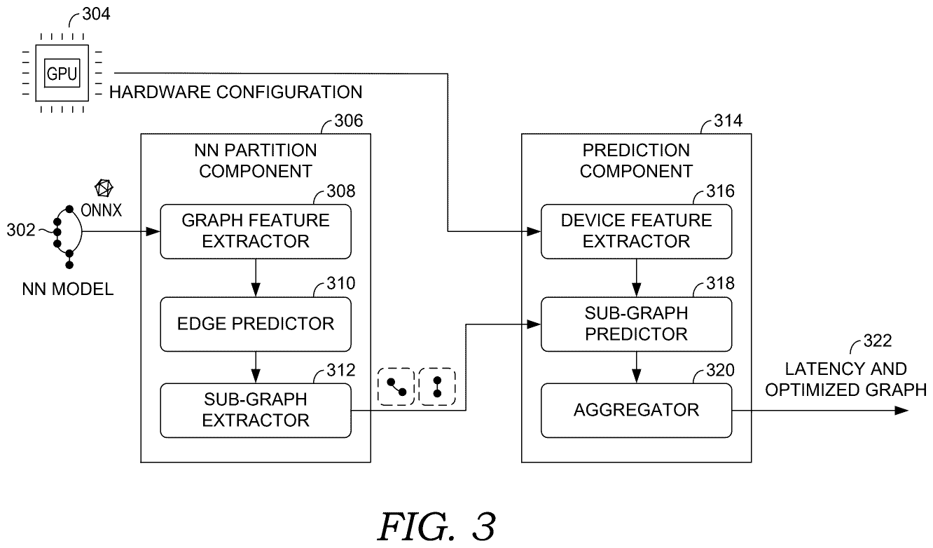

In some aspects, the neural network partition component 110 and the prediction component 112 employ a graph-based approach in which a target neural network is represented by a graph and the machine learning models employed by the components comprise graph neural networks (GNNs). With reference now to FIG. 3, a block diagram is provided that illustrates a graph-based approach in accordance with some configurations. As shown in FIG. 3, a target neural network 302 and a target hardware configuration 304 are provided as input. The target neural network 302, which can comprise a neural network representation in a standard format such as ONNX, is provided as input to a neural network partition component 306 (which can correspond to the neural network partition component 110 of FIG. 1). The neural network partition component 306 partitions the target neural network 302 into layer groups in this example configuration using a graph feature extractor 308, an edge predictor 310, and a sub-graph extractor 312.

The graph feature extractor 308 converts the target neural network 302 into a graph format in which each node of the graph corresponds to a layer of the target neural network 302 with edges between nodes in the graph based on connected layers in the target neural network 302. The graph feature extractor 308 extracts layer features for the nodes, for instance, based on computational semantics of the neural network layers. In other words, the graph feature extractor 308 extracts layer features and converts the target neural network 302 to a general graph format G=(V, E), such that V ∈ [symbol] represents the layers in the neural network, where n is the number of layers and d is the dimension of the layer features. E={(vᵢ, vⱼ)} represents the edges for all vᵢ, vⱼ ∈ V such that the output of vᵢ is the input of vⱼ.

To represent the structural and computational semantics of a target neural network, the graph feature extractor 308 can extract a variety of different layer features. Table 1 below provides examples of various layer features that can be employed. The operator type indicates the computational complexity and the optimization methods (e.g., fusion) that may apply to the layer. The input, output, and parameter size of the layer can affect the memory access, communication overhead, and fusibility. FLOPs represents the computational requirement of the layer.

TABLE 1
Layer Features

| Type | Name | Description | Example Value |
|---|---|---|---|
| Operator | Operator type | Operator type or | Conv2d |
| | | layer type. | |
| Memory | Input size | The total number of | 150528 (i.e. |
| | | elements in input | 1 × 3 × |
| | | tensors. | 224 × 224) |
| | Output size | The total number of | 1000 |
| | | elements in output | |
| | | tensors. | |
| | Parameter size | The total number of | 9472 |
| | | weights and | |
| | | bias in this layer. | |
| Computation | FLOPs | The total number of | 115806208 |
| | | floating | |
| | | point operations | |
| | | performed by this | |
| | | layer. | |

The edge predictor 310 employs a GNN model (which can correspond to the partition model 208 of FIG. 2) to predict whether each edge in the graph connects two fusible layers. Partitioning a neural network (e.g., by kernel) involves identifying the layers that can be fused together. Some aspects of the technology described herein represent this fusibility relationship by labeled edges. Specifically, two layers can be fused only if they are connected by an edge. More generally, k layers, V′={v₁, . . . vₖ} where vᵢ ∈ V, can be fused only if there exists a set of edges E′⊆ E such that the sub-graph F (V′,E′) is connected. Based on this, the set U=UE′, for all fusible sub-graphs F (V′,E′)⊆G, are defined as fusible edges. As such, the task of the GNN model used by the edge predictor 310 is to classify whether each edge in the graph is a fusible edge or not.

In some aspects, the GNN model used by the edge predictor 310 comprises a Graph Attention (GAT)-long short-term memory (LSTM) model, although other model architectures can be employed in other aspects. In such configurations, the GNN model includes a GAT layer followed by a LSTM layer. The GAT layer extracts node features by processing the graph-structure data. The GAT layer exploits the local structure and neighborhood information of nodes in the graph using message-passing and attention mechanisms. As such, the GAT layer models relational information and dependencies between nodes. In some configurations, each GAT layer has 128 hidden channels and is designed as GAT-GraphSizeNorm-ReLU pattern, where GraphSizeNorm is used to normalize node features and defined as:

$${x}^{′} = \frac{{x}^{′}}{\sqrt{\vert V \vert}}$$

Some aspects employ an LSTM layer with 128 hidden channels to encode the edge features to provide edge embeddings for the edges. The inputs of the LSTM layer are sequences with length 2, [xᵢ, xⱼ], where xᵢ, xⱼ are node embeddings output from the GAT layer for node vᵢ, vⱼ and (vᵢ, vⱼ) ∈ E. This preserves the layer order information, which can affect the fusion decision. For example, conv-relu can be fused but relu-conv cannot. Following the LSTM layer, a linear layer is used to make the final classification for each edge in the graph based on the edge embeddings—i.e., labeling each edge as fusible or not fusible.

Once the edges are labeled, the sub-graph extractor 312 partitions the graph into multiple sub-graphs, such that all nodes within the same sub-graph can be fused and executed by a single kernel or operator. As such, each sub-graph comprises a layer group with one or more layers from the target neural network 302. The sub-graph extractor 312 divides the original graph into sub-graphs based on fusible labels of the edges. As previously indicated, fusible edges are defined by fusible layers. Conversely, given the predicted fusible edges, the fusible layers can be determined. This is based on the observation that one layer can only be executed by one kernel; in other words, kernels are disjoint sets of layers. As such, the sub-graph extractor 312 partitions the graph's nodes into disjoint sets, where each set represents a group of nodes connected by predicted fusible edges. In some aspects, the sub-graph extractor 312 applies Union-Find data structure. The data structure is set up such that each node initially belongs to its own unique set containing only itself. Then, for all predicted fusible edge (vᵢ, vⱼ) ∈ U, we merge nodes vi and vi into a single set. Consequently, the resulting sets identify sub-graphs in which the layers can be fused together. An example pseudocode for extracting sub-graphs is shown below in algorithm 1.

Algorithm 1: Extract sub-graphs

| Input: V a set of nodes in the origin DNN graph; | | | |
|---|---|---|---|
| E a set of edges in the origin DNN graph, with | | | |
| predicted is_fusible label. | | | |
| Output: Assign group label for all vᵢ ϵ V such that | | | |
| vᵢ.group == vⱼ.group if and only if vᵢ, vⱼ can be | | | |
| fused and executed by one kernel. | | | |
| 1 | Function Find(parents, v): | | |
| 2 | \| | if parents [v] != v then | |
| 3 | \| | \| | parents [v] = Find(parents, parents[v]) |
| 4 | \| | \| | return parents [v] |
| 5 | \| | else | |
| 6 | \| | \| | return v |
| 7 | \| | end | |
| 8 | End Function | | |
| 9 | Function Union(parents, vᵢ, vⱼ): | | |
| 10 | \| | pᵢ = Find(parents, vᵢ) | |
| 11 | \| | pⱼ = Find(parents, vⱼ) | |
| 12 | \| | if pᵢ != pⱼ then | |
| 13 | \| | \| | parents [vⱼ] = pᵢ |
| 14 | \| | end | |
| 15 | End Function | | |
| 16 | parents [vᵢ] = i | | |
| 17 | for e = (vᵢ, vⱼ) ϵ E do | | |
| 18 | \| | if e.is fusible then | |
| 19 | \| | \| | Union(vᵢ, vⱼ) |

| | | |
|---|---|---|
| 20 | \| | end |

| | |
|---|---|
| 21 | end |

The prediction component 314 (which can correspond to the prediction component 112 of FIG. 1) estimates the total latency of the target neural network 302 on the target hardware configuration 304 by individually analyzing the sub-graphs produced by the neural network partition component 306. As shown in FIG. 3, the prediction component 314 in this example configuration includes: a device feature extractor 316, a sub-graph predictor 318, and an aggregator 320.

The device feature extractor 316 extracts a set of device features D for the target hardware configuration 304. Table 2 below provides examples of various device features that can be employed to represent the memory and computational semantics of a target hardware configuration. The device features are concatenated with the node features in the sub-graphs in order to integrate hardware knowledge into the prediction process.

TABLE 2
Device Features

| | | | Example |
|---|---|---|---|
| Type | Name | Description | Value |
| Version | Compute | This feature identifies | 8.6 |
| | capability | the set of features | |
| | | supported by GPU. | |
| Memory | Memory | The amount of data in | 384 |
| | bus width | bits that can be | |
| | | transferred at one | |
| | | time. | |
| | Memory | The speed of GPU's | 6.251 |
| | clock rate | memory in GHz. | |
| Computation | Number of cores | The number of GPU cores. | 10240 |
| | Number of SM | The number of stream | 80 |
| | | multi-processor. | |
| | Compute clock | The speed of GPU | 6.251 |
| | rate | cores in GHz | |

The sub-graph predictor 318 employs another GNN model to estimate the latency of each sub-graph generated by the neural network partition component 306. In some aspects, the GNN model also predicts a specific kernel to execute each sub-graph. Since different kernels have different execution characteristics, knowing which kernels are used can help identify potential performance bottlenecks and better understanding the predicted latency. In some aspects, the GNN model used by the sub-graph predictor 318 comprises a GAT model that includes a regressor that predicts the latency for each sub-graph and a classifier that predicts the kernel for each sub-graph.

The tasks of the sub-graph predictor 318 can be defined as follows. Given an undirected graph G=(V, E), [symbol] denotes the kernel type domains, where k ∈ [symbol] 0 is a specific kernel implementation. In some aspects, the following mapping function g is learned:

$$g : V \times E \times D \to ,$$

By incorporating device-specific attributes, the sub-graph predictor 318 achieves the ability to be cognizant of the resource allocation. Some aspects use undirected graphs in this task because the directions appear to have minimal impact on the latency and kernel implementation. In some configurations, the GNN model used by the sub-graph predictor 318 includes three GAT layers followed by one linear classifier layer. Each GAT layer has 256 hidden channels and is designed as the GAT-GraphSizeNorm-ReLU pattern. GlobalMeanAggregation is used to aggregate node features to graph features.

The aggregator 320 combines the latencies of all sub-graphs to predict the final end-to-end latency for the target neural network 302 on the target hardware configuration 304. As the execution of each sub-graph is independent and the neural network executes all of them, the aggregator 320 models the end-to-end latency as the sum of the individual sub-graph latencies predicted by the sub-graph predictor 318. In some aspects, the aggregator 320 also reassembles the sub-graphs into an optimized representation of the target neural network 302. The optimization representation can be, for instance, an optimized graph where each node represents a layer group with one or more layers from the target neural network, each of which can labeled with the predicted kernel type and/or predicted latency. Accordingly, an output 322 is provided that indicates the total latency, the optimized graph, and/or other information.

The model used by the edge predictor 310 to label edges of graph representations of neural networks can be trained on a training dataset that identifies whether pairs of layers can be fused. In some cases, the training dataset is designed for training a GNN model and contains nodes representing layer features and edges between the nodes with edge labels indicating if the connected nodes can be fused. The edge labels serve as ground truth when training the GNN model. In some aspects, cross entropy loss is used to train this GNN model by predicting edge labels and comparing the predicted edge labels with the ground truth edge labels from the training data.

The model used by the sub-graph predictor 318 to predict sub-graph latencies and kernels can be trained on a training dataset that pairs latency and kernel information with layer groups having layers that can be fused and executed by a single operation. Each layer group identifies the primitive layers that form the layer groups. To train this multi-task model, both root mean squared error (RMSE) and cross entropy loss (CE) can be used to formulate the loss function, such that:

$$L = R MSE ( {y}_{reg}^{\hat{}} , {y}_{r e g} ) + CE ( {y}_{cls}^{\hat{}} , {y}_{c l s} )$$

where ŷ_{reg}, y_{reg} are predicted values and ground truth values of latency; and ŷ_{cis}, y_{cis} are predicted values and ground truth values of kernel type.

In some aspects, the datasets used to train the models can be generated by running different neural network models on different hardware configurations to collect runtime optimization and performance data. To provide a robust training dataset, the neural network models can have a wide spectrum of model structures and the hardware configurations can have a wide spectrum of device characteristics. Additionally, the performance of the neural networks can be assessed across a range of GPU allocations (e.g., ranging from 10% to 100% of the GPU capacity in 10% increments).

With reference again to FIG. 1, the model analysis system 104 further includes a user interface component 114 that provides one or more user interfaces for interacting with the model analysis system 104. The user interface component 114 provides one or more user interfaces to a user device, such as the user device 102. In some instances, the user interfaces can be presented on the user device 102 via the application 108, which can be a web browser or a dedicated application for interacting with the model analysis system 104. For instance, the user interface component 114 can provide user interfaces for, among other things, inputting a target neural network and target hardware configuration to the model analysis system 104. The user interface component 114 can also provide user interfaces presenting outputs from the model analysis system 104. The output can include, for instance, a total latency prediction for executing the target neural network on the target hardware configuration. The output can further include details regarding the neural network partitioning. The details provided for each layer group can include, for instance, an indication of the layer(s) from the target neural network, a latency prediction, and a kernel prediction. The user interfaces can further present an optimized graph showing the layer groups and details of each (e.g., underlying layer(s) from the target neural network, latency prediction, and/or kernel prediction).

The model analysis system 104 can provide any of a number of different modes of analysis for selecting hardware configurations for target neural networks. By way of example only and not limitation, in some configurations, a user can provide a target neural network and a target hardware configuration, and the model analysis system 104 can provide latency prediction information for presentation. As another example, a user can provide a target neural network and a latency threshold, and the model analysis system 104 can provide an indication (e.g., a recommendation) of one or more hardware configurations that satisfy the latency threshold for the target neural network. For instance, the model analysis system 104 can determine a latency prediction for one or more target hardware configurations for the target neural network, compare each latency prediction to the latency threshold, and provide a recommendation for each target hardware configuration in which the latency prediction satisfies the latency threshold.

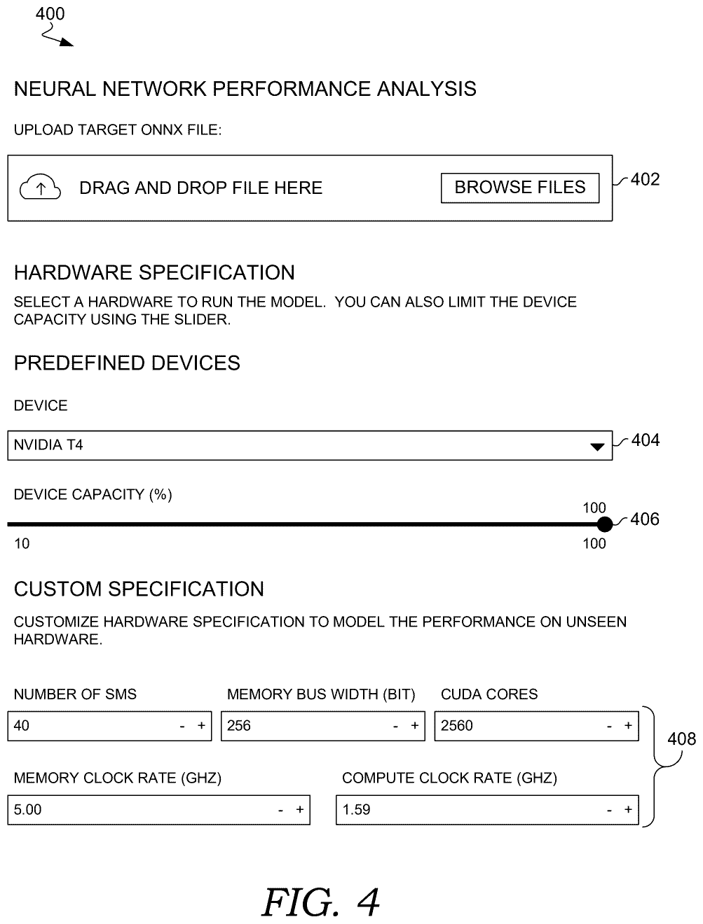

FIG. 4 is a diagram showing a user interface 400 for inputting a target neural network and a target hardware configuration for generating a latency prediction. As shown in FIG. 4, the user interface includes an interface element 402 for selecting a target neural network for which latency prediction will be performed. For instance, a user could select a neural network file in standard format, such as ONNX. The user interface 400 also includes a user interface element 404 for selecting a particular device, such as a particular GPU model, for the target hardware configuration. This could comprise, for instance, a drop down box for selecting from a number of pre-defined devices. A user interface element 406 (a slider in this example) is also provided that allows a user to specify a device capacity for executing the target neural network (e.g., 0-100%). The user interface 400 further includes a collection of user interface elements 408 allowing a user to specify custom aspects of a target hardware configuration, such as number of stream multiprocessors (SM), memory bus width, Compute Unified Device Architecture (CUDA) cores, memory clock rate, and compute clock rate.

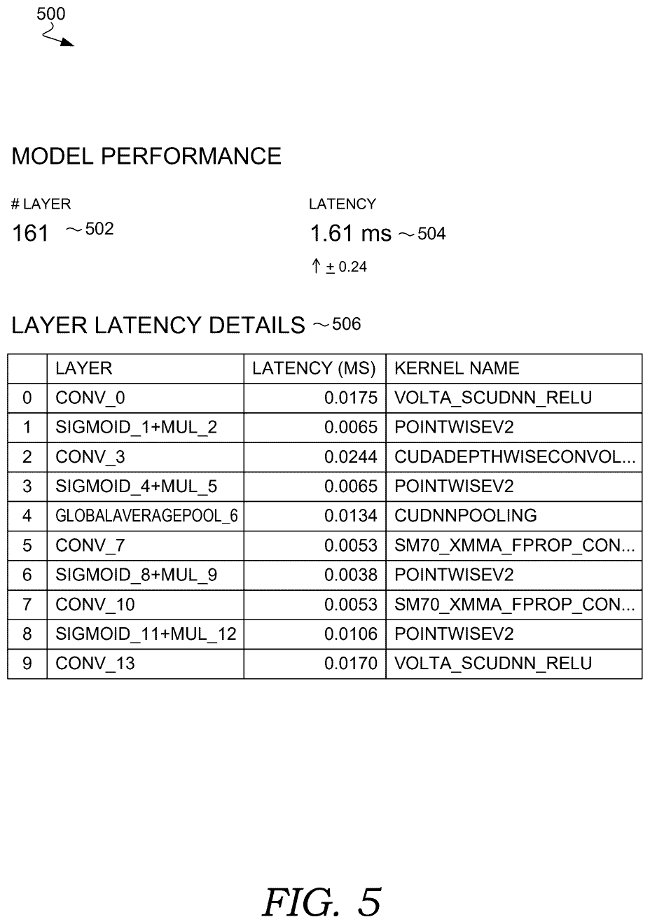

FIG. 5 is a diagram showing a user interface 500 providing a latency prediction and layer latency details for executing a target neural network on a target hardware configuration (e.g., received via the user interface 400 of FIG. 4). As shown in FIG. 5, the user interface 500 provides a number of layers 502 for the neural network resulting after grouping layers by partitioning the target neural network. In other words, each layer in the number of layers 502 comprises a layer group resulting from the partition process that includes a single layer or multiple layers from the target neural network that can be executed by a single operation. The user interface 500 also provides a total latency 504 for executing the target neural network on the target hardware configuration. The total latency 504 can comprise a sum of the latency predictions for each layer group of the partitioned neural network. The user interface 500 further includes layer details 506 that provide, for each layer group, an indication of the layer(s) from the target neural network, a latency prediction, and a predicted kernel.

### Example Methods for Latency Prediction for Model Serving

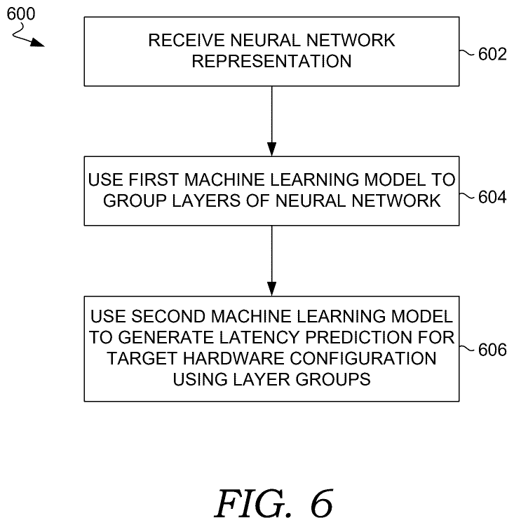

With reference now to FIG. 6, a flow diagram is provided that illustrates an overall method 600 for predicting a latency of executing a target neural network on a target hardware configuration. The method 600 may be performed, for instance, by the model analysis system 104 of FIG. 1. Each block of the method 600 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 602, a representation of a target neural network is received. For instance, a neural network representation in a standard format, such as ONNX, could be received that identifies the layers of the target neural network and the connections between layers. A first machine learning model (e.g., the partition model 208 of FIG. 2) is used to partition the target neural network into layer groups, as shown at block 604. Each each layer group includes a single layer from the target neural network or multiple layers from the target neural network that can be executed using a single operation. A second machine learning model (e.g., the prediction model 214 of FIG. 2) is used to generate a latency prediction for executing the target neural network on a target hardware configuration, as shown at block 606. In some aspects, the second machine learning model predicts a latency for each layer group, and the total latency is generated as a sum of the layer group latencies. In some aspects, the second machine learning model also predicts a kernel for each layer group.

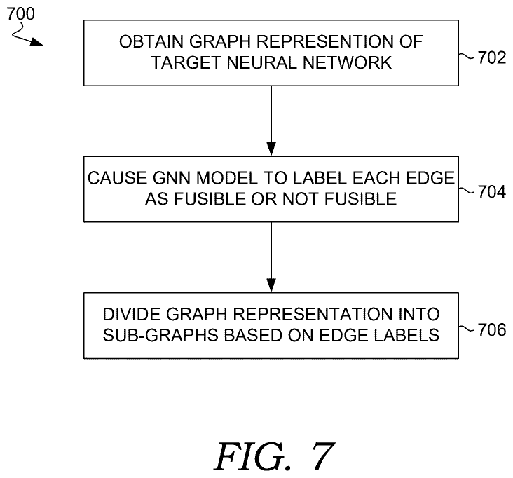

FIG. 7 is a flow diagram showing a method 700 for employing a GNN model to partition a target neural network, which could be performed at block 604 of FIG. 6 in some configurations. The method 700 could be performed, for instance, by the neural network partition component 306 of FIG. 3. As shown at block 702, a graph representation of a target neural network is obtained. The graph representation includes nodes representing each layer of the target neural network with layer features and edges between nodes representing connections between layers of the target neural network.

A GNN model is used to label each edge in the graph representation as fusible or not fusible, as shown at block 704. The graph representation is divided into sub-graphs based on the edge labels as shown at block 706. Each sub-graph is a single layer or a set of two or more layers whose edges between the layers are labeled as fusible. As such, each sub-graph is a layer group with one or more layers from the target neural network that can be executed using a single operation. The method

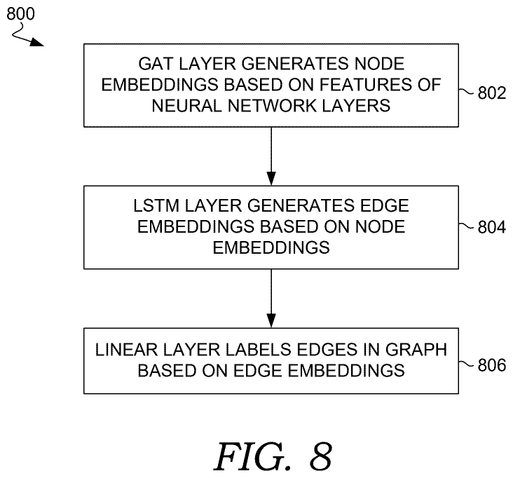

FIG. 8 is a flow diagram showing a method 800 for a GNN model to label edges of a graph representation of a target neural network, which could be performed at block 704 of FIG. 7. The method 800 could be performed, for instance, by the edge predictor 310 of FIG. 3. As shown at block 802, a GAT layer generates node embeddings based on features of neural network layers from a graph representation of a target neural network. The node embeddings are provided as input to an LSTM layer, which generates edge embeddings. A linear layer labels the edges in the graph representation of the target neural network based on the edge embeddings, as shown at block 806.

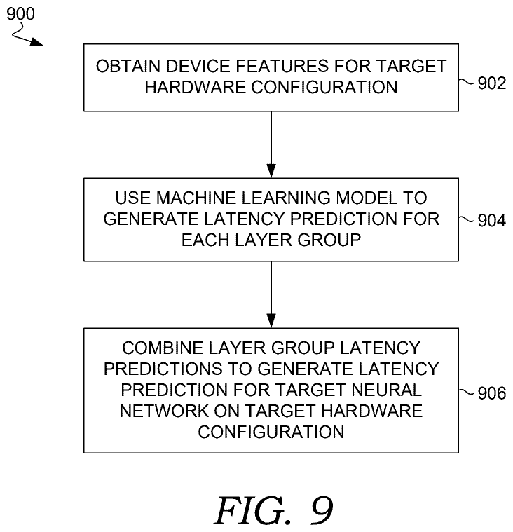

FIG. 9 is a flow diagram showing a method 900 for using a machine learning model to predict a latency for executing a target neural network on a target hardware configuration, which could be performed at block 606 of FIG. 6. The method 900 could be performed, for instance, by the prediction component 314 of FIG. 3. As shown at block 902, device features for a target hardware configuration are obtained. A machine learning model (e.g., a GNN) is used to generate a latency prediction for each layer group identified from partitioning a target neural network (e.g., via the method 700 of FIG. 7), as shown at block 904. The layer group latency predictions are combined at block 906 to generate a latency prediction for executing the target neural network on the target hardware configuration.

### Exemplary Operating Environment

Having described implementations of the present disclosure, an exemplary operating environment in which embodiments of the present technology may be implemented is described below in order to provide a general context for various aspects of the present disclosure. Referring initially to FIG. 10 in particular, an exemplary operating environment for implementing embodiments of the present technology is shown and designated generally as computing device 1000. Computing device 1000 is but one example of a suitable computing environment and is not intended to suggest any limitation as to the scope of use or functionality of the technology. Neither should the computing device 1000 be interpreted as having any dependency or requirement relating to any one or combination of components illustrated.

The technology may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 10, computing device 1000 includes bus 1010 that directly or indirectly couples the following devices: memory 1012, one or more processors 1014, one or more presentation components 1016, input/output (I/O) ports 1018, input/output components 1020, and illustrative power supply 1022. Bus 1010 represents what may be one or more busses (such as an address bus, data bus, or combination thereof). Although the various blocks of FIG. 10 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 10 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 10 and reference to “computing device.”

Computing device 1000 typically includes a variety of computer-readable media. Computer-readable media can be any available media that can be accessed by computing device 1000 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1000. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1012 includes computer storage media in the form of volatile and/or nonvolatile memory. The memory may be removable, non-removable, or a combination thereof. Exemplary hardware devices include solid-state memory, hard drives, optical-disc drives, etc. Computing device 1000 includes one or more processors that read data from various entities such as memory 1012 or I/O components 1020. Presentation component(s) 1016 present data indications to a user or other device. Exemplary presentation components include a display device, speaker, printing component, vibrating component, etc.

I/O ports 1018 allow computing device 1000 to be logically coupled to other devices including I/O components 1020, some of which may be built in. Illustrative components include a microphone, joystick, game pad, satellite dish, scanner, printer, wireless device, etc. The I/O components 1020 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 1000. The computing device 1000 may be equipped with depth cameras, such as, stereoscopic camera systems, infrared camera systems, RGB camera systems, and combinations of these for gesture detection and recognition. Additionally, the computing device 1000 may be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described herein may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology may generally refer to the technical solution environment and the schematics described herein, it is understood that the techniques described may be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
receiving a neural network representation for a target neural network having a plurality of layers;
grouping, using a first machine learning model, layers of the target neural network to provide a plurality of layer groups based on the neural network representation, at least one layer group comprising multiple layers from the target neural network that can be executed by a single operation; and
generating, using a second machine learning model, a latency prediction for executing the target neural network on a target hardware configuration based on the layer groups.

2. The one or more computer storage media of claim 1, wherein grouping the layers of the target neural network using the first machine learning model comprises:
obtaining a graph representing the target neural network, the graph including nodes representing the layers of the target neural network and edges between the nodes based on connections between the layers of the target neural network;
causing the first machine learning model to label each edge in the graph as fusible or not fusible to provide edge labels; and
generating the layer groups by dividing the graph into sub-graphs based on the edge labels.

3. The one or more computer storage media of claim 2, wherein causing the first machine learning model to label each edge in the graph as fusible or not fusible to provide the edge labels comprises:
generating, using a graph attention (GAT) model of the first machine learning model, node embeddings based on features of the layers of the target neural network;
generating, using a long short-term memory (LSTM) model of the first machine learning model, edge embeddings based on the node embeddings; and
labeling, using a linear model of the first machine learning model, the edges in the graph based on the edge embeddings.

4. The one or more computer storage media of claim 1, wherein generating the latency prediction using the second machine learning model comprises:
obtaining device features for the target hardware configuration;
generating, using the second machine learning model, layer group latency predictions for the layer groups based on the device features; and
combining the layer group latency predictions to generate the latency prediction.

5. The one or more computer storage media of claim 4, wherein obtaining the device features for the target hardware configuration comprises receiving user-based input identifying one or more selected from the following: a hardware device identifier, a memory bus width, a memory clock rate, a number of cores, a number of stream-multiprocessors, and a compute clock rate.

6. The one or more computer storage media of claim 4, wherein each layer group is represented as an undirected graph when processed by the second machine learning model to generate the layer group latency predictions.

7. The one or more computer storage media of claim 4, wherein the operations further comprise:
determining, using the second machine learning model, a kernel for each layer group; and
providing an indication of the kernel for each layer group for presentation.

8. The one or more computer storage media of claim 1, wherein the operations further comprise:
providing the latency prediction for presentation on a user device.

9. The one or more computer storage media of claim 1, wherein the operations further comprise:
providing a recommendation for the target hardware configuration based on the latency prediction satisfying a latency threshold.

10. The one or more computer storage media of claim 1, wherein the operations further comprise:
generating an optimized graph representing the target neural network, the optimized graph including nodes representing the layer groups and edges between the nodes based on connections between the layer groups; and
providing a graphical representation of the optimized graph for presentation.

11. The one or more computer storage media of claim 10, wherein each node of the optimized graph provides an indication of one or more layers from the target neural network and an indication of a kernel predicted by the second machine learning model.

12. A computer-implemented method comprising:
generating a graph representation of a target neural network, the graph representation including nodes representing layers of the target neural network and edges between the nodes representing connections between the layers in the target neural network;
causing a first graph neural network model to generate edge labels identifying the edges of the graph representation as fusible or not fusible based on layer features associated with the nodes;
partitioning the graph into a plurality of sub-graphs based on the edge labels;
causing a second graph neural network model to generate a latency prediction for each sub-graph based on the layer features associated with each node in each sub-graph and devices features of a target hardware configuration; and
generating a total latency prediction for the target neural network by aggregating the latency predictions for the sub-graphs.

13. The computer-implemented method of claim 12, wherein the first graph neural network includes: a graph attention (GAT) model that generates node embeddings based on the layer features associated with the nodes; a long short-term memory (LSTM) model that generates edge embeddings based on the node embeddings; and a linear model that generates the edge labels based on the node embeddings.

14. The computer-implemented method of claim 12, wherein the method further comprises receiving the device features for the target hardware configuration by receiving user-based input identifying one or more selected from the following: a hardware device identifier, a memory bus width, a memory clock rate, a number of cores, a number of stream-multiprocessors, and a compute clock rate.

15. The computer-implemented method of claim 12, wherein the operations further comprise:
causing the second graph neural network to select a kernel for each sub-graph; and
providing an indication of the kernel for each sub-graph for presentation.

16. The computer-implemented method of claim 12, wherein the operations further comprise:
providing a recommendation for the target hardware configuration based on the total latency prediction satisfying a latency threshold.

17. The computer-implemented method of claim 12, wherein the operations further comprise:
generating an optimized graph representing the target neural network, the optimized graph including nodes representing the sub-graphs and edges between the nodes based on connections between the sub-graphs, wherein each node of the optimized graph provides an indication of one or more layers from the target neural network and an indication of a kernel; and
providing a graphical representation of the optimized graph for presentation.

18. A computer system comprising:
one or more processors; and
one or more computer storage media storing computer-useable instructions that, when used by the one or more processors, causes the computer system to perform operations comprising:
obtaining a graph representation of a target neural network, the graph representation including nodes representing layers of the target neural network and edges between the nodes representing connections between the layers in the target neural network;
labeling, by a first graph neural network model, the edges of the graph representation as fusible or not fusible to provide edge labels by:
generating, using a graph attention (GAT) model of the first graph neural network model, node embeddings based on layer features associated with the nodes in the graph representation,
generating, using a long short-term memory (LSTM) model of the first graph neural network model, edge embeddings based on the node embeddings, and
labeling, using a linear model of the first graph neural network model, the edges in the graph representation based on the edge embeddings to provide the edge labels;
partitioning the graph into a plurality of sub-graphs based on the edge labels;
receiving device features for a target hardware configuration;
causing a second graph neural network model to generate a latency prediction and a kernel prediction for each sub-graph based on the layer features associated with each node in each sub-graph and the devices features of the target hardware configuration; and
generating a total latency prediction for the target neural network by aggregating the latency predictions for the sub-graphs.

19. The computer system of claim 17, wherein the operations further comprise:
generating an optimized graph representing the target neural network, the optimized graph including nodes representing the sub-graphs and edges between the nodes based on connections between the sub-graphs, wherein each node of the optimized graph provides an indication of one or more layers from the target neural network and an indication of the predict kernel for the sub-graph represented by the node; and
providing a graphical representation of the optimized graph for presentation.

20. The computer system of claim 18, wherein the operations further comprise:
providing a recommendation for the target hardware configuration based on the total latency prediction satisfying a latency threshold.
